(19) United States
(12) Patent Application Publication
(10) Pub. No.: US 2010/0261111 A1
(43) Pub. Date: Oct. 14, 2010

(54) TONER, IMAGE FORMING METHOD AND IMAGE FORMING APPARATUS

(75) Inventors: Tomohiro ARUGA, Matsumoto-shi (JP); Hideki OKADA, Shiojiri-shi (JP); Yoichi YAMADA, Shiojiri-shi (JP); Daisuke MATSUMOTO, Matsumoto-shi (JP)

Correspondence Address: Workman Nydegger;1000 Eagle Gate Tower, 60 East South Temple, Salt Lake City, UT, 84111, US

(73) Assignee: SEIKO EPSON CORPORATION, Tokyo (JP)

(21) Appl. No.: 12/759,448

(22) Filed: Apr. 13, 2010

(30) Foreign Application Priority Data
Apr. 14, 2009 (JP) 2009-097942

(51) Int. Cl. G03G 9/00; G03G 15/08

(52) U.S. Cl. 430/105; 399/284; 430/110.4

(57) ABSTRACT

A toner includes at least a binder resin, a colorant, and a release agent. The toner contains base toner particles having an average volume particle size of 2 μm to 6 μm, small particle silica having an average volume particle size of 7 nm to 15 nm, large particle silica having an average volume particle size of 50 nm to 400 nm, small particle transition alumina having an average volume particle size of 7 nm to 20 nm, and large particle α-type alumina having an average volume particle size of 50 nm to 400 nm or large particle cerium oxide having an average volume particle size of 50 nm to 400 nm.

### BACKGROUND

1. Technical Field

The present invention relates to a toner, an image forming method and an image forming apparatus.

2. Related Art

Conventionally, as an image forming apparatus, there is a mode in which a photoreceptor, such as a photoreceptor drum or a photoreceptor belt, which is a latent image carrier, is rotatably supported on a body of an image forming apparatus, an electrostatic latent image is formed on a photosensitive layer of the photoreceptor at an image forming operation, the latent image is converted into a visual image in a contact or non-contact manner by a toner, and then the visual image is directly transferred onto a transfer material by using corona transfer or a transfer roller, or a mode in which the visual image is firstly transferred onto an intermediate transfer medium, such as a transfer drum or a transfer belt, and then is re-transferred onto a transfer material. In these image forming apparatuses, two-component toner is generally known as toner which can perform relatively reliable development. However, since a mixing ratio of a developing agent and a magnetic carrier easily fluctuates, its maintenance is needed. Further, one-component magnetic toner has a problem in that a sharp color image cannot be obtained due to the opacity of the magnetic material.

Recently, it is reported that there are concerns that dust, which is contained in a cooling air flow discharged outwardly from an image forming apparatus of an electrographic type, has a harmful effect on a human body. As a standard of restricting the dust in the air, there is a fine particulate matter (PM2.5) studied by the Ministry of the Environment. It is reported that a legal guideline is initiated as an environmental standard, and it is expected that an external additive, which has charge leak ability and which is separated from the surface of the toner and is discharged outwardly from the image forming apparatus during image forming operation, is one cause of a dust generating risk. Further, it seems that the reduction in the size of toner particles has is continued for the purpose of sharp image, in particular small particle toner having a volume average particle size of 2 to 4 μm has become mainstream. In a system of forming an image by applying an AC (alternating current) electric field between the developing roller and the photoreceptor, there is concern over risks that since the toner is moved onto the photoreceptor while reciprocating under a development electric field, a part of the toner which is activated in a cloud state under the development electric field gets into an air flow coming in the image forming apparatus, so that the toner particles itself, as well as the external additive, become dust.

In such a small particle toner, since the number of toner particles increase in an exponential manner in comparison with common toner, it is very difficult to speed up and uniformize the charging of the toner. As a result, there are many problems, such as fogging, toner scattering, leakage, a developing history or the like, due to nonuniformity in the charging of the toner. As a general method of improving the charging of the toner, there has been known a so-called regulating bias (JP-A-2005-331780) which sets a potential difference between a regulating blade and the developing roller. In the regulating bias, if the potential difference is set so as to be high, the charging of the toner is improved. However, if the potential difference is too high, it leads to local concentration of electron migration, which causes generation of toner clusters, occurrence of charging polarity reversed toner, white spots on a toner transport surface, or the like. Since a limit level of the potential difference is dramatically low for the small particle toner, a sufficient effect is not obtained by the regulating bias method.

Further, the toner particles are carried on the surface of the developing roller and are pressed on the layer thickness regulating member, so that the toner particles are charged by friction with the pressed surface or the layer thickness regulating member. Some developing rollers are provided on a toner carrying surface thereof with fine concave/convex portions by performing a blast process on the surface. In the concave/convex portions, the size, depth, shape and displacement form of the concave portion are not uniform. For this reason, for example, since the toner particles entering a deep concave portion are not rotated, the toner particles may not be effectively charged. Due to the nonuniformity of the concave/convex portions on the surface of the developing roller, the charging defect of the toner particles may happen locally, or the toner particle may enter a small concave portion which leads to filming. In addition, in a case in which the toner particles are not effectively charged, the toner particles leak from the developing device, so that the toner particles may be scattered in the image forming apparatus or scattered outwardly from the image forming apparatus.

### SUMMARY

An advantage of some aspects of the invention is that it provides to a toner, an image forming method and an image forming apparatus, in which uniformity of charging is superior even with small particle toner having an average volume particle size of 2 μm to 6 μm, in particular, 2 μm to 4 μm, and the toner is not scattered in the image forming apparatus or not scattered outwardly from the image forming apparatus due to leakage from a developing device.

A toner of the invention includes at least a binder resin, a colorant, and a release agent, wherein there is contained base toner particles having an average volume particle size of 2 μm to 6 μm, small particle silica having an average volume particle size of 7 nm to 15 nm, large particle silica having an average volume particle size of 50 nm to 400 nm, small particle transition alumina having an average volume particle size of 7 nm to 20 nm, and large particle α-type alumina having an average volume particle size of 50 nm to 400 nm or large particle cerium oxide having an average volume particle size of 50 nm to 400 nm.

The base toner particles have an average particle size of 2 μm to 4 μm and are manufactured by an emulsion polymerization method.

An image forming method of the invention includes a photoreceptor that carries an electrostatic latent image; and a developing device that is positioned opposite to the photoreceptor in a non-contact state, the developing device including a developing roller having a surface carrying toner for developing the electrostatic latent image carried on the photoreceptor, and spiral groove portions with an inclination with respect to an axial direction and a circumferential direction formed on the surface at a regular pitch in the axial direction, a supply roller for supplying the toner to the developing roller, and a layer thickness regulating member applying a regulating bias to the developing roller to carry the toner on the developing roller, wherein the electrostatic latent image carried on the photoreceptor is developed under an AC electric field by supplying the toner to the developing device, and the toner includes at least a binder resin, a colorant, and a release agent, in which there is contained base toner particles having an average volume particle size of 2 μm to 6 μm, small particle silica having an average volume particle size of 7 nm to 15 nm, large particle silica having an average volume particle size of 50 nm to 400 nm, small particle transition alumina having an average volume particle size of 7 nm to 20 nm, and large particle α-type alumina having an average volume particle size of 50 nm to 400 nm or large particle cerium oxide having an average volume particle size of 50 nm to 400 nm.

An image forming apparatus of the invention includes a photoreceptor that carries an electrostatic latent image; and a developing device that is positioned opposite to the photoreceptor in a non-contact state, the developing device including a developing roller having a surface carrying toner for developing the electrostatic latent image carried on the photoreceptor, and spiral groove portions with an inclination with respect to an axial direction and a circumferential direction formed on the surface at a regular pitch in the axial direction, a supply roller for supplying the toner to the developing roller, and a layer thickness regulating member applying a regulating bias to the developing roller to carry the toner on the developing roller, wherein the electrostatic latent image carried on the photoreceptor is developed under an AC electric field by supplying the toner to the developing device, and the toner includes at least a binder resin, a colorant, and a release agent, in which there is contained base toner particles having an average volume particle size of 2 μm to 6 μm, small particle silica having an average volume particle size of 7 nm to 15 nm, large particle silica having an average volume particle size of 50 nm to 400 nm, small particle transition alumina having an average volume particle size of 7 nm to 20 nm, and large particle α-type alumina having an average volume particle size of 50 nm to 400 nm or large particle cerium oxide having an average volume particle size of 50 nm to 400 nm.

According to the toner, the image forming method and the image forming apparatus of the invention, the uniformity of the charging is superior even with small particle toner having an average volume particle size of 2 μm to 6 μm, in particular, 2 μm to 4 μm, and the toner is not scattered in the image forming apparatus or not scattered outwardly from the image forming apparatus due to leakage from a developing device.

### BRIEF DESCRIPTION OF THE DRAWINGS

The invention will be described with reference to the accompanying drawings, wherein like numbers reference like elements.

FIG. 1 is a view illustrating the general of an image forming apparatus of the invention.

FIG. 2 is a view illustrating major constituent elements of a developing device.

FIG. 3 is a view illustrating a surface shape of a developing roller.

FIG. 4 is a view illustrating a cross section of a developing roller which is taken along a plane passing through the axis.

FIG. 5 is a view illustrating an aspect in which a developing roller is fabricated by rolling.

FIG. 6 is a view illustrating the order of fabricating a developing roller.

FIG. 7 is a view illustrating a state in which a regulating blade comes in contact with a developing roller carried with toner particles.

### DESCRIPTION OF EXEMPLARY EMBODIMENTS

A base toner particle in the invention is a colored particle of a small particle size, and is preferably obtained by an emulsion aggregation method. However, the base toner particles may be obtained by a phase inversion emulsion integrating method or a crushing method.

In the emulsion aggregation method, monomer, polymerization initiator, emulsifier (surfactant) and the like are dispersed and polymerized in water, and then are mixed with a dispersing agent consisting of formed resin particles, a colorant, a release agent, a charging control agent, if necessary, and a dispersing agent such as an aggregating agent (electrolyte). The mixture is agglutinated and thermally fused to obtain coloring particles. The obtained coloring particles are further mixed with a dispersing agent consisting of resin particles, and a core shell structure is formed by letting the colorant as a core and adhering, heating and fusing the resin particles to form a coated layer (shell), thereby preventing a release agent component from being exposed to the surface of the coloring particles of the release agent component and thus preventing a wax (release agent) component from being adhered to a device such as a developing roller or the like. Further, it is possible to effectively collect the base toner particles by preventing the filming.

In the toner fabricated by the emulsion aggregation method, the monomer includes, for example, styrene, o-methyl styrene, m-methyl styrene, p-methyl styrene, α-methyl styrene, p-methoxy styrene, p-ethyl styrene, vinyl toluene, 2,4-dimethyl styrene, p-n-butylstyrene, p-phenylstyrene, p-chlorostyrene, divinylbenzene, methyl acrylate, ethyl acrylate, acrylic acid propyl, n-butyl acrylate, isobutyl acrylate, n-octyl acrylate, dodecyl acrylate, hydroxyethyl acrylate, 2-ethylhexyl acrylate, benzyl acrylate, stearyl acrylate, 2-ethyl chloride acrylate, methyl methacrylate, ethyl methacrylate, propyl methacrylate, n-butyl methacrylate, isobutyl methacrylate, n-octyl methacrylate, dodecyl methacrylate, hydroxyethyl methacrylate, 2-ethylexyl methacrylate, stearyl methacrylate, phenyl methacrylate, acrylic acid, methacrylate, maleate, fumarate, cinnamic acid, ethylene glycol, propylene glycol, maleic anhydride, phthalic anhydride, ethylene, propylene, butylene, isobutylene, phoyvinyl chrolide, vinylidene chloride, vinyl bromide, vinyl fluoride, vinyl acetate, vinyl propylene acid, acrylonitrile, methacrylnitrile, vinylmethylether, ethyl vinyl ether, vinyl ketone, vinyl hexyl ketone, and vinyl naphthalene. Among the above lists, styleneallyl-based copolymer is preferable in view of the chargeable property.

Further, the colorant includes pigments and dyes, for example, carbon black, lampblack, magnetite, titanium black, chrome yellow, ultramarine blue, aniline blue, phthalocyanine blue, phthalocyanine green, Hansa yellow G, rhodamine 6G, carcoil blue, quinacridone, benzidine yellow, rose Bengal, malachite green rake, quinoline yellow, C.I. pigment•red 48:1, C.I. pigment•red 57:1, C.I. pigment•red 122, C.I. pigment•red 184, C.I. pigment•yellow 12, C.I. pigment•yellow 17, C.I. pigment•yellow 97, C.I. pigment•yellow 180, C.I. solvent•yellow 162, C.I. pigment•blue 5:1, C.I. pigment•blue 15:3. The colorant may be used alone or in combination of plural kinds.

The release agent includes, for example, paraffin wax, micro wax, microcrystalline wax, candelilla wax, carnauba wax, rice wax, montan wax, polyethylene wax, polypropylene wax, oxidized polyethylene wax, and oxidized polypropylene wax. It is preferable that the polyethylene wax, the polypropylene wax, the carnauba wax, and ester wax are used among the above list.

The polymerization initiator in the emulsion aggregation method includes, for example, potassium persulfate, sodium persulfate, ammonium persulfate, hydrogen peroxide, 4,4′-azobis-cyanovaleric acid, t-butylhydroperoxide, benzoyl peroxide, and 2,2′-azobis-isobutyronitrile.

The emulsifier (surfactant) includes, for example, dodecylbenzenesulfonate sodium, tetradecylbenzenesulfonate sodium, pentadecylbenzenesulfonate sodium, sodium octyl sulfate, sodium oleate, sodium laurate, potassium stearate, calcium oleate, dodecylammonium chloride, dodecylammonium bromide, dodecyltryiammonium bromide, dodecylpyridinium bromide, hexatrimethylammonium bromide, dodecylpolyoxyethylene ether, hexadecylpolyoxyethylene ether, laurylpolyoxyethylene ether, and sorbitan monooleate polyoxyethylene ether.

The aggregating agent (electrolyte) includes, for example, sodium chloride, potassium chloride, lithium chloride, magnesium chloride, calcium chloride, sodium sulfate, potassium sulfate, lithium sulfate, magnesium sulfate, calcium sulfate, zinc sulfate, aluminum sulfate, and iron sulfate.

As a component ratio of the coloring particles (base toner particles), for the polymerization monomer of 100 parts by weight, the release agent is 3 to 10 parts by weight, preferably 4 to 8 parts by weight, and the colorant is 3 to 15 parts by weight, preferably 5 to 10 parts by weight.

Further, for the polymerization monomer of 100 parts by weight, the polymerization initiator in the emulsion polymerization is 0.03 to 2 parts by weight, preferably 0.1 to 1 part by weight, the emulsifier (surfactant) is 0.01 to 0.1 parts by weight, and the aggregating agent (electrolyte) is 0.05 to 5 parts by weight, preferably 0.1 to 2 parts by weight.

In addition, the toner obtained by the phase inversion emulsion integrating method may be used. The phase inversion emulsion integrating method is disclosed in Japanese Patent No. 3,867,893, which the toner is obtained by sequentially performing (1) a first process in which a mixture containing at least polyester resin and an organic solvent is emulsified in an aqueous vehicle to form particulates of the mixture in the aqueous vehicle, (2) a second process in which a dispersion stabilizing agent is added and the electrolyte is sequentially further added to unify the particulates and thus manufacturing clusters of the particulates, and (3) a third process in which after the organic solvent contained in the aggregate is removed therefrom, the particulates are separated, washed and dried from the aqueous vehicle. Further, if the styrene acrylic resin is used as the binder resin, moisture resistance is superior, thereby employing a binder resin having superior charging stability. Further, if the polyester resin is used as the binder resin, it is suitable for a color image since transparency of an obtained image is superior.

According to the invention, the particle size of the coloring particles (base toner particles) are measured by a Multisizer III model produced by Beckman Coulter, and 50% volume average particle size (D₅₀) is 2.0 to 6.0 μm, preferably 2.0 to 4.0 μm. If the average particle size is 6.0 μm or less, even though a latent image is formed at a high resolution of 600 dpi or more, the reproducibility of the resolution is superior. In this instance, if the average particle size is 2.0 μm or less, the developing efficiency is deteriorated, and thus concealing by the toner is deteriorated. A use amount of the external additive is increased so as to enhance the flow, and thus the fixing ability is deteriorated.

As a shape of the base toner particles, toner particles having a shape close to a true sphere are preferable, and more specifically, the base toner particles have an average degree of circularity (R) of 0.95 to 0.99, preferably 0.96 to 0.98, which is represented by the following equation:

R=L₀/L₁

(wherein, in the equation, L₁(μm) is a surrounding distance of a projection image of the toner particle which are the objects to be measured, and L₀(μm) is a surrounding distance of a true circle (absolute geometric circle) having the same area as an area of the projection image of the toner particles which are the object to be measured.) Consequently, the toner has the following advantages: the transfer efficiency is high; a fluctuation of the transfer efficiency is low even using continuous printing; the charging amount is stabilized; and the cleaning ability is superior. The average degree of circularity of the toner is measured by a flow particle shape analyzer (FPIA-2100 produced by Sysmex Corporation).

A method of manufacturing the base toner particles used in the invention will now be described. Hereinafter, the term ‘parts’ means parts by weight.

Preparation of Resin Particulate Dispersion solution
styrene . . . 370 g
n-butyl acrylate . . . 30 g
acrylic acid . . . 8 g
dodecane thiol . . . 24 g
carbon tetrabromide . . . 4 g

A solution obtained by mixing and dissolving the above elements is dispersed and emulsified in 550 g of ion exchanged water having 6 g of a nonionic surfactant (Nonipole 400 produced by Sanyo Chemical Industries, Ltd.) and 10 g of an anionic surfactant (Neogen SC produced by Dai-ichi Kogyo Seiyaku Co., Ltd.) dissolved therein in a flask, and then 50 g of ion exchanged water is added dissolved with 4 g of ammonium persulfate under slow stirring over 10 minutes. After nitrogen substitution, the content of the flask is heated to 70° C. by an oil bath under stirring to continue emulsion polymerization for 5 hours. As a result, a resin particulate dispersion solution, in which resin particles are dispersed, having an average particle size of 150 nm, a glass transition point (Tg) of 58° C., and a weight average molecular weight Mw of 11500 is obtained. The solid content concentration of the dispersion solution is 40 wt %.

Preparation of Colorant Dispersion Solution
cyan pigment B15:3 . . . 60 g
nonionic surfactant . . . 5 g
   (Nonipole 400 produced by Sanyo Chemical Industries, Ltd.)
ion exchanged water . . . 240 g

The above elements are mixed and dissolved, and the mixture is stirred by a homogenizer (Ultra-Turrax T50 produced by IKA) for 10 minutes. After that, the mixture is dispersed by an ultimaizer to obtain a colorant dispersion solution, in which colorant particles are dispersed, having an average particle size of 250 nm.

### Preparation of Release Agent

polyethylene wax . . . 100 g
   (PW725 produced by Toyo Petrolite Co., Ltd.)
ionic surfactant . . . 5 g
   (Neogen RK produced by Dai-ichi Kogyo Seiyaku Co., Ltd.)
ion exchanged water . . . 200 g

The solution obtained by mixing the above elements is heated to 95° C., and then is sufficiently dispersed by a homogenizer (Ultra-Turrax T50 produced by IKA). After that, the solution is dispersed by a pressure discharge-type homogenizer to prepare a release agent, in which release agent particles are dispersed, having an average particle size of 210 nm.

### Preparation of Base Toner Particles

resin particulate dispersion solution prepared by the above . . . 234 parts
colorant dispersion solution prepared by the above . . . 30 parts
release agent dispersion solution prepared by the above . . . 40 parts
poly aluminum chloride . . . 1.8 parts
   (PAC100W produced by Asada Chemical Industry Co., Ltd.)
ion exchanged water . . . 600 parts

The above elements are mixed and dispersed in a circular flask made of stainless steel by a homogenizer (Ultra-Turrax T50 produced by IKA), and then is heated to 50° C. by an oil bath under stirring in the flask. After the mixture is maintained at 50° C. for 30 minutes, it is verified that the clustered particles having D₅₀ (volume average particle size) of 2.4 μm are formed. Further, the mixture is maintained at 56° C. for 1 hour by increasing the temperature of the oil bath for heating, and thus D₅₀ (volume average particle size) becomes 2.8 μm.

After that, the dispersion solution containing the clustered particles is mixed with a resin particulate dispersion solution of 26 parts by weight, and then the temperature of the oil bath for heating is raised and maintained at 50° C. for 30 minutes. The dispersion solution containing the clustered particles is added with 1N sodium hydrate to adjust the pH of the system to 5.0. The flask made of stainless steel is closed, and then the content of the flask is heated to 95° C. under continuously stirring and is maintained at 95° C. for 4 hours to capsulate the content. After cooling, it is filtered and washed four times by ion exchanged water, and then it is lyophilized to obtain the base toner particles. D₅₀ of the base toner particles (surface area average particle size) is 3.0 μm.

Next, the external additive particles forming a feature of the invention will be described. In the average particle size (hereinafter referred to as particle size) of the external additive particles, the particle sizes of 100 particles in view are measured by using a transmission electron microscope to obtain an average particle size. Further, a BET specific surface area is obtained by using an automatic specific surface area analyzer ‘Macsorb HM model-1201’ produced by Mountech Co., Ltd.

The small particle silica has a primary particle size of 7 to 15 nm, preferably 10 to 12 nm, a absolute specific gravity of 0.1 to 0.2 g/cm³, and two-component charging amount (5 min value) of −20 to −80 μC/g, and ‘R8200’ or ‘RX200’ produced by Aerosil Co. (a absolute specific gravity of 0.02 to 0.06 g/cm³ and two-component charging amount (5 min value) of −100 to −300 μC/g) is exemplified. They are obtained from a silicon halogen compound through vapor phase oxidization (dry method), which is different from the absolute specific gravity and the two-component charging amount (5 min value).

For a small silica particle of a hydrophobic property, as the primary particle size is small, the flow of the obtained toner is high. If the primary particle size is less than 7 nm, the silica particulate may be buried in the base toner particles at the external addition. In contrast, if the primary particle size is more than 16 nm, the flow may be deteriorated. The small silica particles of a hydrophobic property of 0.5 to 3.0 parts by weight, preferably 1.0 to 2.0 parts by weight are added for the base toner particles of 100 parts by weight.

In this instance, a rod is passed through a measuring cylinder of 100 ml to introduce powder, the introduction is stopped when it reaches 100 ml, and weight is measured. The measured weight is substituted in the following equation to obtain the absolute specific weight.

Absolute specific weight (g/cm³)={(weight after insertion of sample)−(weight before insertion of sample)}/{capacity of measuring cylinder (100 ml)}

Next, for the large particle silica, the primary particle size is 50 to 400 nm. The shape of the large particle silica of Wadell is a sphere in such a manner that the degree of sphericity is 0.6 or more, preferable 0.8 or more. The large particle silica is obtained by a sol-gel method which is a wet method, and its specific weight is 1.3 to 2.1. In the large particle silica, if the average particle size is less than 50 nm, the flow or charging stability is not maintained by preventing it from being buried on the surface of the base toner particles of the silica particulates with small particles size, or a spacer effect is not obtained. If the average particle size is more than 400 nm, it is difficult for the large particle silica to adhere on the base toner particles, and there are easily detached from the surface of the base toner particle.

As the large particle silica, ‘Seahostar KE-P10S’ produced by Nippon Shokubai Co., Ltd. (primary particle size of 100 nm) or the like is exemplified. A crystal type is amorphous which is regarded as partial crystalline, a shape is spherical, and the primary particle size is 100 nm. The large particle silica is subjected to a hydrophobizing (surface) process by silicon oil, of which absolute specific gravity is 2.2, absolute specific gravity is 0.25 to 0.35, BET specific surface area is 10 to 14 m²/g, and two-component charging amount (5 min value) is 0 to −50 μC/g.

The large particle silica of 0.2 to 2.0 parts by weight, preferably 0.5 to 1.5 parts by weight for the base toner particles of 100 parts by weight. If a content amount of the large particle silica is less than 0.2 parts by weight, toner filling density is increased. When the toner layer is regulated as a thin layer by the regulating blade, it is difficult to reduce the thickness of the toner, thereby causing problems of regulation leakage and scattering. Further, if the large particle silica is added more than 2.0 parts by weight, the filling density of the toner layer is excessively lowered. When the toner layer is passes through the regulating blade when the developing roller rotates, a part of the toner is not maintained by the developing roller, but is leaked. Further, since the toner layer is unevenly formed in the layer thickness at a cycle of the developing roller, if a solid color image is output on the whole surface, the concentration uniformity in a transport direction of paper is deteriorated, thereby causing a problem in which the cycle of the developing roller is uneven.

An addition ratio (weight ratio) of the large particle silica to the small particle silica is 1:4 to 4:1, preferably 2:3 to 3:2, thereby achieving the toner flow and obtaining the stability of the charging over the long term. The large particle silica and the small particle silica are added in an amount of 1.25 to 5.0 parts by weight, preferably 2.0 to 3.0 parts by weight, in total for the base toner particles of 100 part by weight in view of both mixing ratio.

It is preferable that the silica particulate is subjected to a hydrophobizing process. The flow and charging property of the toner are further improved by achieving a hydrophobic property on the surface of the silica particulate. The hydrophobization of the silica particulate is performed by the method widely known in those in the art, such as a wet method or a dry method, by using a silane compound, such as hexamethyldisilazane or dimethyldichlorsilan, or silicon oil such as dimethyl silicon, methylphenyl silicon, fluorine-modified silicone oil, alkyl-modified silicon oil, or epoxy-modified silicon oil.

In addition, positively chargeable silica particles may be added. The positively chargeable silica particles have a primary particle size of 20 nm to 40 nm. It is preferable that the positively chargeable silica particles are subjected to a hydrophobizing process. The positively chargeable silica particles are added so as to reduce a fluctuation of charging properties due to change of external environment, maintain reliable charging properties and improve flow of the toner. The hydrophobization of the positively chargeable silica particle is performed by using aminosilane-modified silicon or amino-modified silicon. As the hydrophobic and positively chargeable silica particle, NA50H commercially available from Nippon Aerosil co., Ltd. (crystal type is amorphous, shape is spherical, primary particle size is 30 nm, it is subjected to a hydrophobizing process by hexamethyldisilazane and aminosilane, absolute specific gravity is 2.2, absolute specific gravity is 0.0671, BET specific surface area is 44.17 m²/g, carbon amount is 2% or less, and two-component charging amount (5 min value) is 40 μC/g) or Cabot produced by Cabot Corporation, or TG820F produced by Cabot Corporation is exemplified.

Next, alumina particulate will be described. In the invention, small particle transition alumina is externally added for the purpose of performing very effective charge reception with minute charge site representative of small particle silica. Alumina of γ-type or θ-type crystalline structure which is transition alumina is superior for such an effect, and in particular, the alumina of θ-type crystalline structure is preferable.

The small particle transition alumina has a primary particle size of 7 nm to 20 nm, preferably 10 nm to 15 nm, and transition alumina, namely θ-type, γ-type, δ-type, and η-type alumina are exemplified as a crystal type. Further, a content amount of the small particle transition alumina is 0.3 parts by weight to 3 parts by weight, preferably 0.5 parts by weight to 1.5 parts by weight, for the base toner particles of 100 parts by weight. If a treatment quantity for the base toner particles is more than the above, there is a problem in that charge leaking action excessively appears, or isolated external additive is generated. Further, if the treatment quantity is less, a desired effect is not obtained.

As a commercialized product, ‘Nano•Tek, Al₂O₃’, of which γ-alumina phase is a main phase, a primary particle size is 30 nm, and a BET specific surface area is 49 m²/g, produced by C.I. Kasei Co., Ltd., ‘Taimicron TM-300, Al₂O₃’, of which γ-alumina phase is a main phase, a primary particle size is 7 nm, and a BET specific surface area is 225 m²/g, produced by Taimei Chemicals Co., Ltd., ‘Taimicron TM-100, Al₂O₃’, of which O-alumina phase is a main phase, a primary particle size is 14 nm, and a BET specific surface area is 132 m²/g, produced by Taimei Chemicals Co., Ltd., and ‘C805, Al₂O₃’, of which γ-alumina phase is a main phase (2/3), δ-alumina phase (1/3) is contained, a particle size is 13 nm, and a BET specific surface area is 100 m²/g, produced by Nippon Aerosil Co., Ltd., are exemplified. Further, since the small particle alumina has a small particle size and the change of mutually physical contact is insufficient, it may not sufficiently function as a charging path for connecting the toners in a case of superimposing continuous printing.

For this reason, α-type alumina with large particle size or cerium oxide with large particle size is externally added in the invention. As the crystalline structure of the large particle alumina, α-type alumina is preferable because of such a superior effect. The α-type alumina of large particle size or the cerium oxide of large particle size has an average particle size of 50 nm to 400 nm, preferably 100 nm to 350 nm. In a case in which sintered clusters exist after the external addition, it is preferable that the particle size of the clusters is within the range. If the average particle size is small, the operation as the charge exchanging path effect for connecting the toners is deteriorated. If the average particle size is more than 400 nm, it is easily isolated from the base toner particles. Further, a content amount of α-type alumina of large particle size or the cerium oxide of large particle size is 0.5 parts by weight to 2.5 parts by weight, preferably 1.0 parts by weight to 1.5 parts by weight, for the base toner particles of 100 parts by weight. If a treatment quantity for the base toner particles is more than the above, there is a problem in that charge leaking effect excessively appears, or isolated external additive is generated. Further, if the treatment quantity is less, a desired effect is not obtained.

For the large particle alumina, as a commercial product, ‘Taimicron TM-DAR, primary particle size of 160 nm’, which is α-alumina of 100% α phase, produced by Taimei Chemicals Co., Ltd., or the like is exemplified. Further, for cerium oxide particles, ‘Type S’, of which a primary particle size is 50 nm to 100 nm, produced by Anan Kasei Co., Ltd., ‘AU’, of which a particle size is 50 nm to 100 nm, produced by Shin-Etsu Chemical Co., Ltd., and ‘UU’, of which a primary particle size is 20 to 50 nm, and the particle size of the sintering clusters is 200 nm to 400 nm, produced by Shin-Etsu Chemical Co., Ltd. are exemplified.

These external additive particulates may be subjected to a hydrophobizing process by a silane-based organic compound such as alkyl alkoxy silane, siloxane, silane or silicon oil. In particular, the use of alkyl alkoxy silane is preferable, and for example, there are vinyl trimethoxy silane, vinyltriethoxy silane, γ-methacryloxypropyl trimethoxy silane, vinyltrichloro silane, methyltrimethoxy silane, methyltriethoxy silane, isobutyltrimethoxy silane, dimethyldimethoxy silane, dimethyldiethoxy silane, trimethylmethoxy silane, hydroxypropyltriethoxy silane, phenyltrimethoxy silane, n-hexadecyltrimethoxy silane, and n-octadecyltrimethoxy silane

A method of adding the external additive to the base toner powder is performed by using Henschel mixer (produced by Mitsui Miike Machinery Co., Ltd.), Q type mixer (produced by Mitsui Mining Co., Ltd.), Mechanofusion System (produced by Hosokawa Micron Co., Ltd), and Mechanomill (produced by Okada Seiko Col. Ltd.). In a case of performing multi-stage process by using the Henschel mixer, a processing condition of each stage is properly selected in a range of circumferential rotation velocity of 30 to 50 m/s and processing time of 2 minutes to 15 minutes.

Further, as the order of adding the external additive, it is performed in multiple stages consisting of two steps, in which the external additive is first treated for the base toner particles in a first step, except for the small particle external additive, and the small particle external additive is treated and adhered in a second step. It is possible to obtain the flow of the small silica and the function of the large particle silica, small particle or large particle alumina and the large particle cerium oxide for prolonged printing.

In this instance, in the invention, in the range of not damaging the above-described purpose of the addition of the external additive particles, other hydrophobized external additives, such as hydrophobic solid silica particle {fumed silica, ‘RX50’ produced by Nippon Aerosil co., Ltd., absolute specific gravity of 2.2 g/cm³, volume average particle size D₅₀=40 μm (standard deviation=20 nm)} may be treated with external addition by magnesium stearate, calcium stearate, zinc stearate, mono aluminum stearate, tri aluminum stearate or the like, as metal salt, selected from zinc, magnesium, calcium, and aluminum, of high fatty acid which are metallic soap particles. Further, particulates of metal oxide such as zinc oxide, strontium oxide, tin oxide, zirconium oxide, magnesium oxide, indium oxide, or titanium oxide, particulates of nitride such as silicon nitride, particulates of carbide such as silicon carbide, resin particles, particulates of metal salt such as calcium sulfate, barium sulfate, calcium carbonate, or strontium titanate, and a compound thereof may be added.

The toner of the invention has a flow softening temperature (Tf1/2) of 90° C. to 140° C. and a glass transition temperature (Tg) of 40° C. to 70° C. The flow softening temperature (Tf1/2) is a value measured by using a flow tester (CFT-500), which is produced by Shimadzu Corporation, under conditions having a nozzle diameter of 1.0 mmφ×1.0 mm and a load of 10 kg per unit area (cm²) at temperature rising velocity of 6° C. per minute. Further, the glass transition temperature (Tg) is a value measured by using Differential Scanning Calorimeter (DSC-220C), which is produced by Seiko Instruments Inc, at temperature rising velocity of 10° C. per minute according to a second run method.

The image forming method and the image forming apparatus according to the invention will now be described.

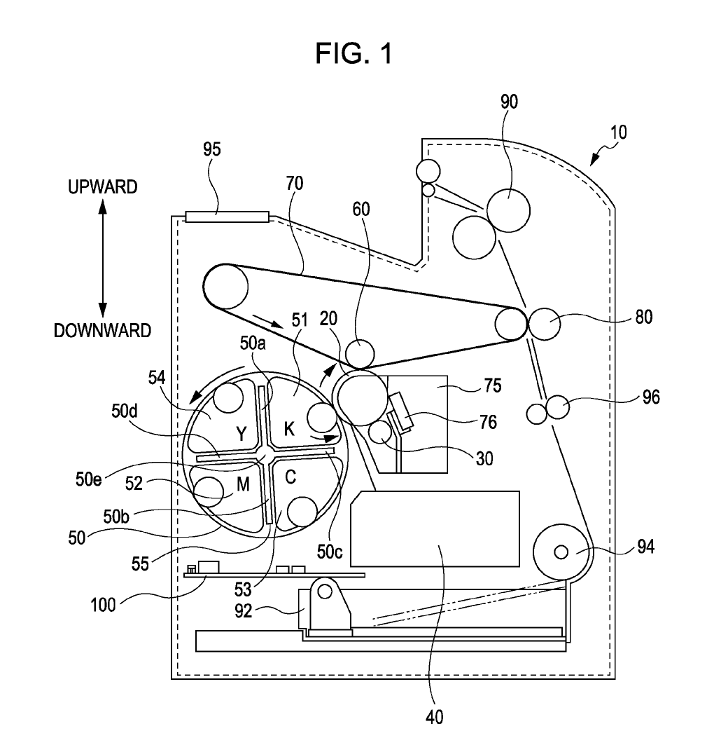

FIG. 1 is a view illustrating the general of the image forming apparatus. In the figure, a printer 10 includes, in a rotation direction of a photoreceptor 20, a charging unit 30, an exposure unit 40, a developer holding unit 50, a primary transfer unit 60, an intermediate transfer member 70, a cleaning unit 75, a secondary transfer unit 80 and a fixing unit 90.

The photoreceptor 20 has a cylindrical conductive substrate and a photosensitive layer formed on an outer circumference thereof, and is rotatable around a center axis. The photoreceptor 20 is rotated in a clockwise direction, as shown by an arrow. The charging unit 30 is a device for charging the photoreceptor 20, and the exposing unit 40 is a device for forming a latent image on the charged photoreceptor 20 by irradiating a laser on the photoreceptor. The exposing unit 40 irradiates the modulated laser beam on the charged photoreceptor 20 based on an image signal. The laser beam is switched ON/OFF at a predetermined timing, and thus a dot-shaped latent image is formed on an area defined in a lattice pattern on the photoreceptor 20 which rotates at a predetermined speed.

The developer holding unit 50 is a device for developing the latent image formed on the photoreceptor 20 by using a black (K) toner contained in a black developer 51, a magenta (M) toner contained in a magenta developer 52, a cyan (C) toner contained in a cyan developer 53, and a yellow (Y) toner contained in a yellow developer 54. The rotation of the developer holding unit 50 can cause positions of the four developers 51, 52, 53 and 54 to be displaced. Whenever the photoreceptor 20 rotates once, one of the four developers 51, 52, 53 and 54 is selectively opposite to the photoreceptor 20, and the latent image formed on the photoreceptor 20 is sequentially developed by the toner contained in the opposite developers 51, 52, 53 and 54.

The primary transfer unit 60 is a device for transferring the monochromatic toner image formed on the photoreceptor 20 to the intermediate transfer member 70. If the four color toners are sequentially overlapped with each other and transferred, a full-color toner image is formed on the intermediate transfer member 70. The intermediate transfer member 70 is an endless belt, and is rotated at the substantially same circumferential velocity as the photoreceptor 20. The secondary transfer unit 80 is a device for transferring the monochromatic toner image or full-color toner image formed on the intermediate transfer member 70 to a recording medium such as paper, film or fabric.

The fixing unit 90 is a device for fusing the monochromatic toner image or full-color toner image transferred onto the recording medium on the recording medium such as paper to form a permanent image. The cleaning unit 75 is installed between the primary transfer unit 60 and the charging unit 30, and has a cleaning blade 76 made of rubber which abuts against the surface of the photoreceptor 20. The cleaning unit 75 is a device for scrapping and removing the toner T remaining on the photoreceptor 20 by the cleaning blade 76 after the toner image is transferred to the intermediate transfer member 70 by the primary transfer unit 60.

The developer holding unit 50 is provided with the black developer 51 accommodating the black (K) toner, the magenta developer 52 accommodating the magenta (M) toner, the cyan developer 53 accommodating the cyan (C) toner, and the yellow developer 54 accommodating the yellow (Y) toner. The configuration of the respective developers is similar, and thus it will now be described only with respect to the cyan developer 53.

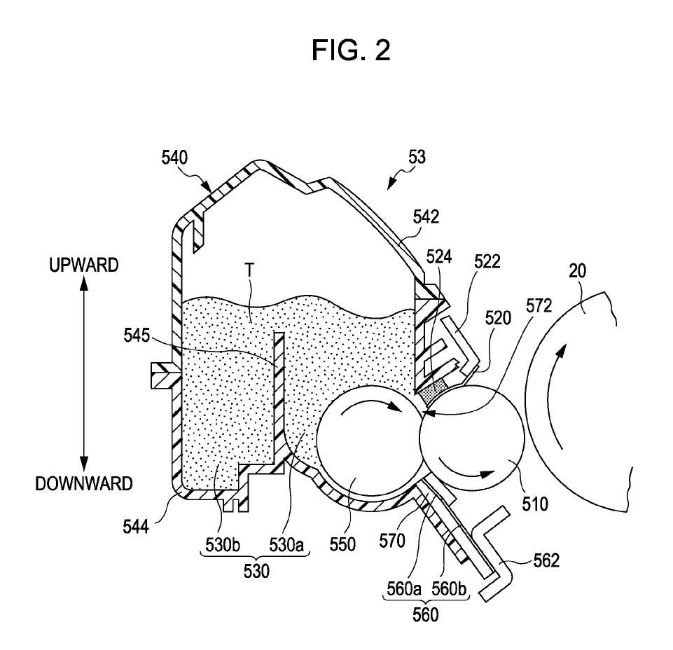

FIG. 2 is a view illustrating the cyan developer as a representative example of the developer, and is a cross-sectional view illustrating major constituent elements of the developer. The developer 53 has a housing 540 accommodating the toner T, a developing roller 510 which is one example of a toner particle carrying roller for carrying the toner, a toner supply roller 550 for supplying the toner to the developing roller 510, a regulating blade 560 which is one example of a layer-thickness regulating member for regulating a layer thickness of the toner carried on the developing roller 510, an upper seal 520 for sealing a gap of a upper side between the housing 540 and the developing roller 510, and an end seal 527 for sealing a gap of an end side between housing 540 and the developing roller 510.

The housing 540 is fabricated by adhering an upper housing portion 542 and a lower housing portion 544 which are integrally formed by using a resin material. The housing is provided with a toner accommodating portion 530 therein as a container for accommodating the toner T. The toner accommodating portion 530 is divided into two toner accommodating portions, that is, a first toner accommodating portion 530a and a second toner accommodating portion 530b, by a partition wall 545 protruding in an inward direction (upward and lower direction in FIG. 2) from an inner wall to separate the toner T.

The first toner accommodating portion 530a and the second toner accommodating portion 530b are linked with each other at the upper portion thereof, but movement of the toner T is restricted by the partition wall 545 in the state shown in FIG. 2. When the developer holding unit 50 rotates, the toners contained in the first toner accommodating portion 530a and the second toner accommodating portion 530b are first collected at a portion which is communicated with the upper side at the development position. When it returns to the state shown in FIG. 2, those toners are mixed and then are returned to the first toner accommodating portion 530a and the second toner accommodating portion 530b. That is, as the developer holding unit 50 rotates, the toners T in the developer are stirred. For this reason, a stirring member is not installed in the toner accommodating portion 530 according to this embodiment, but a stirring member for stirring the toner T contained in the toner accommodating portion 530 may be installed. As shown in FIG. 2, the housing 540 is provided with an opening 572 at a lower portion thereof, and the developing roller 510 described below is installed toward the opening 572.

The toner supply roller 550 is constituted by a roller portion 550a made of, for example, urethane foam having elasticity, and a shaft 550b operating as a rotation center of the roller portion 550a. The toner supply roller 550 is supported by the housing 540 at both ends of the shaft 550b, so that the toner supply roller 550 is rotatably supported around the shaft 550b. The roller portion 550a is accommodated in the above-described first toner accommodating portion 530a (in the housing 540) of the housing 540, and supplies the toner T contained in the first toner accommodating portion 530a to the developing roller 510. The toner supply roller 550 is installed vertically underneath the first toner accommodating portion 530a. The toner T contained in the first toner accommodating portion 530a is supplied to the developing roller 510 at the lower portion of the first toner accommodating portion 530a by the toner supply roller 550. Further, the toner supply roller 550 scraps the surplus toner T which remains on the developing roller 510 after development, from the developing roller 510.

The toner supply roller 550 and the developing roller 510 are assembled in the housing 540 in a mutually pressed state. For this reason, the roller portion 550a of the toner supply roller 550 abuts against the developing roller 510 in an elastically deformed state. The toner supply roller 550 rotates in a direction (clockwise direction in FIG. 2) opposite to a rotation direction (counterclockwise direction in FIG. 2) of the developing roller 510. The shaft 550b is positioned at a position lower than a rotation center axis of the developing roller 510.

The developing roller 510 carries and transports the toner T to the development position opposite to the photoreceptor 20. The developing roller 510 is made of a metal material, that is, an aluminum alloy, such as 5056 aluminum alloy or 6063 aluminum alloy, or an iron alloy such as STKM or the like, and if necessary, may be plated with nickel or chrome. The surface of the developing roller 510 is provided with a spiral groove portion at a center portion of the surface in an axial direction of the developing roller 510. The surface shape of the developing roller 510 will be described in detail hereinafter.

Further, the developing roller 510 is supported at both ends thereof in a longitudinal direction, and is rotatable around a center axis. As shown in FIG. 2, the developing roller 510 rotates in a direction (counterclockwise direction in FIG. 2) opposite to a rotation direction (clockwise direction in FIG. 2) of the photoreceptor 20. The center axis thereof is positioned at a position lower than a center axis of the photoreceptor 20.

In addition, as shown in FIG. 2, there is a gap between the developing roller 510 and the photoreceptor 20 in a state in which the yellow developer 54 is opposite to the photoreceptor 20. That is, the yellow developer 54 develops the latent image formed on the photoreceptor 20 in a non-contact state. In this instance, when the latent image formed on the photoreceptor 20 is developed, an alternative electric field is formed between the developing roller 510 and the photoreceptor 20.

The regulating blade 560 imparts charges to the toner T carried on the developing roller 510, and regulates the layer thickness of the toner T carried on the developing roller 510. The regulating blade 560 has a rubber portion 560a and a rubber support portion 560b. The rubber portion 560a is made of silicon rubber, urethane rubber or the like, and the rubber support portion 560b is a thin plate, having a spring property, made of phosphor bronze, stainless or the like. The rubber portion 560a is supported at one longitudinal side of the rubber support portion 560b in a longitudinal direction of the rubber support portion 560b, and the rubber support portion 560b is attached to the housing 540 through a blade support plate 562 in a state in which the other end of the rubber support portion 560b is supported at the blade support plate 562. Further, a blade rear-surface member 570 made of light seal gasket or the like is installed at a side opposite to the developing roller 510 side of the regulating blade 560.

Further, a regulating bias is applied between the regulating blade 560 and the developing roller 510 so as to impart charges to the toner T, according to the invention. A difference in potential of 70 V to 400 V, preferably 100 V to 300 V, is formed as the regulating bias. In case of using a negatively charged toner, the layer thickness of the toner is regulated by applying high negative potential to the regulating blade 560 side in comparison with the developing roller 510. In case of applying an AC voltage to the developing roller, an AC voltage is applied to the regulating blade in synchronization with the AC voltage, so as to form a desired potential difference.

The rubber portion 560a is pressed against the developing roller 510 from the center portion of the developing roller to both ends thereof by the elastic force due to the bending of the rubber support portion 560b. Further, the blade rear-surface member 570 prevents the toner T from entering between the rubber support portion 560b and the housing 540 to stabilize the elastic force due to the bending of the rubber support portion 560b. In addition, the blade rear-surface member 570 presses the rubber portion 560a in a direction of the developing roller 510 from the rear surface side of the rubber portion 560a, thereby pressing the rubber portion 560a against the developing roller 510. Consequently, the blade rear-surface member 570 enhances the uniform abutting ability of the rubber portion 560a to uniformly abut against the developing roller 510.

The end portion, namely a distal end, of the regulating blade 560 which is opposite to the end portion thereof supported at the blade support plate 562 does not cone into contact with the developing roller 510. A portion spaced apart from the distal end portion at a predetermined distance comes in contact with the developing roller 510 at a width. In other words, the regulating blade 560 does not abut against the developing roller 510 at an edge, but the rubber portion 560a abuts against the developing roller 510 with a mid portion at a plane of the rubber portion. Further, since the regulating blade 560 is placed in such a manner that a distal end thereof faces the upstream side of the developing roller 510 in the rotation direction, which is, so called, counter contact. In this instance, a position, in which the regulating blade 560 abuts against the developing roller 510, is lower than the center axis of the developing roller 510, and also is lower than the center axis of the toner supply roller 550.

In addition, the rubber support portion 560b is installed longer along an axial direction of the developing roller 510 than the rubber portion 560a, and is extended toward an outer side thereof to be longer than both ends of the rubber portion 560a. An end seal 527 made of, for example, a non-woven fabric having a thickness thicker than the rubber portion 560a is adhered to the extended portion of the rubber support portion 560b on the same surface thereof as the rubber portion 560a. In this instance, the end face of the rubber portion 560a in the axial direction thereof abuts against the lateral surface of the end seal 527.

The end seal 527 is installed so as to abut against both ends of the developing roller 510, of which no groove is formed on the surface of the developing roller 510, when the end seal 527 is attached to the developing roller 510. The end seal 527 has a width extending to a portion closer to the outer side than the end of the developing roller 510. Further, the end seal 527 is extended sufficiently longer than the distal end of the rubber portion 560a of the regulating blade 560. If the regulating blade 560 is attached to the housing 540, the end seal 527 follows the portion of the housing 540 which is formed opposite to the outer circumference of the developing roller 510, and closes the gap between the housing 540 and the developing roller 510.

The upper seal 520 prevents the toner T in the yellow developer 54 from leaking outwardly from the developer, and collects the toner T passing through the development position on the developing roller 510 in the developer without scrapping and removing the toner. The upper seal 520 is a seal made of a polyethylene film or the like. The upper seal 520 is supported by a seal support plate 522, and is attached to the housing 540 through the seal support plate 522. Further, the upper seal 520 is provided with a seal pressing member 524 made of urethane foam or the like at a portion opposite to the developer roller 510 side, and the upper seal 520 is pressed on the developing roller 510 by the elastic force of the seal pressing member 524. In this instance, the abutting position, in which the upper seal 520 abuts against the developing roller 510, is upper than the center axis of the developing roller 510.

### Operation of Cyan Developer 53

In the cyan developer 53 configured as described above, the toner supply roller 550 supplies the toner T contained in the toner accommodating portion 530 to the developing roller 510. The toner T supplied to the developing roller 510 reaches to the abutting position of the regulating blade 560 in accordance with rotation of the developing roller 510. When the toner passes through the abutting position, the toner is imparted with the charges, and the layer thickness is regulated.

The toner T on the charged developing roller 510 reaches the development position opposite to the photoreceptor 20 by further rotation of the developing roller 510, and is provided to the development of the latent image formed on the photoreceptor 20 at the development position under the alternative electric field. The toner T, which passes the development position by further rotation of the developing roller 510, on the developing roller 510 passes through the upper seal 520, and is collected in the developer so as not be scrapped and removed by the upper seal 520. Further, the toner T still remaining on the developing roller 510 can be scraped by the toner supply roller 550.

### Surface Shape of Developing Roller

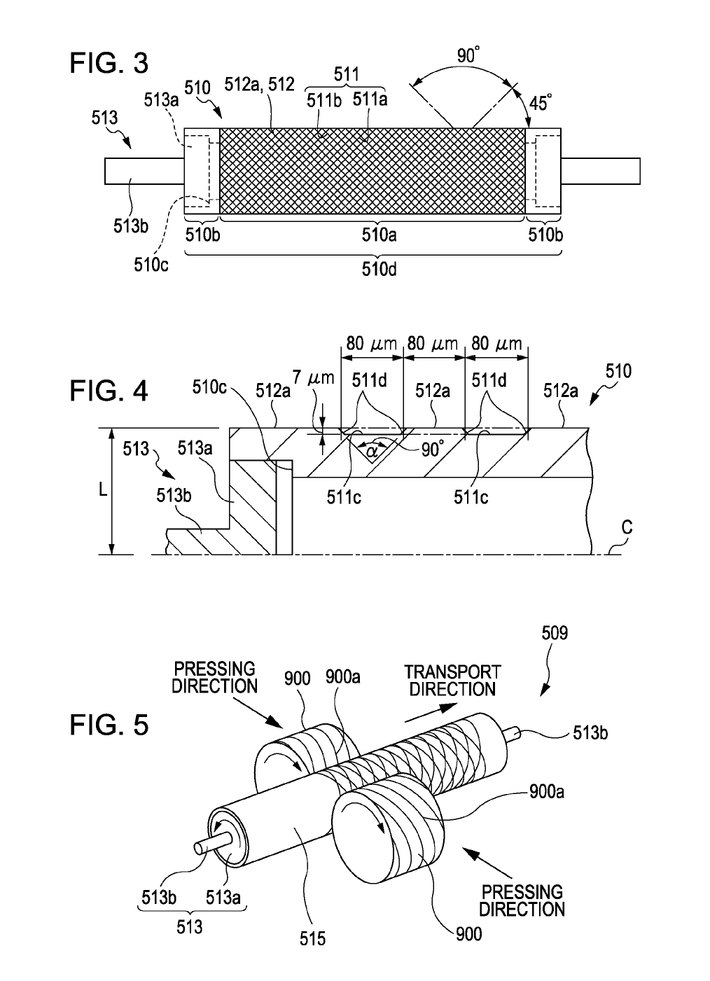

FIG. 3 is a conceptual diagram illustrating the surface shape of the developing roller. FIG. 4 is a cross-sectional view illustrating a cross section of the developing roller which is taken along a plane passing through the axis. Although the groove portion on the surface of the developing roller 510 is shown in a straight form in FIG. 3 for convenience sake, since the groove portion is formed in a spiral form, the groove portion is formed to be seen in a curved line accurately.

The developing roller 510 is provided on a center portion 510a in an axial direction thereof with a concave/convex portion for carrying the toner particles, and has a smooth circumference on both ends 510b so as to come in close contact with the end seal 527.

As shown in FIG. 3, in this embodiment, the center portion 510a of the developing roller 510 is provided with spiral groove portions 511 having an inclination with respect to an axial direction and a circumferential direction of the developing roller 510, with the spiral groove portions being formed at regular pitch. Two kinds of groove portions 511 are formed in different angles of inclination with respect to the axial direction and the circumferential direction of the developing roller 510. The two kinds of groove portions 511 intersect with each other to form a lattice pattern, and a top surface 512a of the convex portion 512 enclosed by two kinds of groove portions 511 is formed in a substantially square shape. Further, two kinds of groove portions 511 are formed in such a manner that one of two diagonal lines of the square top surface 512a of the convex portion 512 runs along a circumferential direction.

That is, one of two kinds of groove portions 511 is formed in a spiral form at an angle of 45° in a clockwise direction with respect to the axis of the developing roller 510, and the other one is formed in a spiral form at an angle of 45° in a counterclockwise direction with respect to the axis of the developing roller 510. For this reason, an intersection angle of the one groove portion 511a and the other grove portion 511b is 90°. Further, since a pitch of the one groove portion 511a and a pitch of the other groove portion 511b in the axial direction of the developing roller 510 are equal to each other, the shape of the top surface 512a of the convex portion 512 enclosed by two kinds of groove portions is substantially a square shape.

Two kinds of groove portions 511 are respectively formed at an interval of 80 μm in the axial direction of the developing roller 510, as shown in FIG. 4, and an angle of the inclined portion 511d extending from the top surface 512a of the convex portion 512 to a bottom surface 511c of the groove portion 511 is formed in such a manner that an intersecting angle α of imaginary planes extending in a direction of an axial center C from two inclined surfaces forming the groove portion 511 is 90°.

Further, the depth of the groove portion 511, namely the distance from the top surface 512a of the convex portion 512 to the bottom surface 511c of the groove portion 511, is constantly formed to be about 7 μm. In a case in which a volume average particle size of the toner is 3 μm, the depth of the groove portion 511 is set to be less than two times the volume average particle size of the toner.

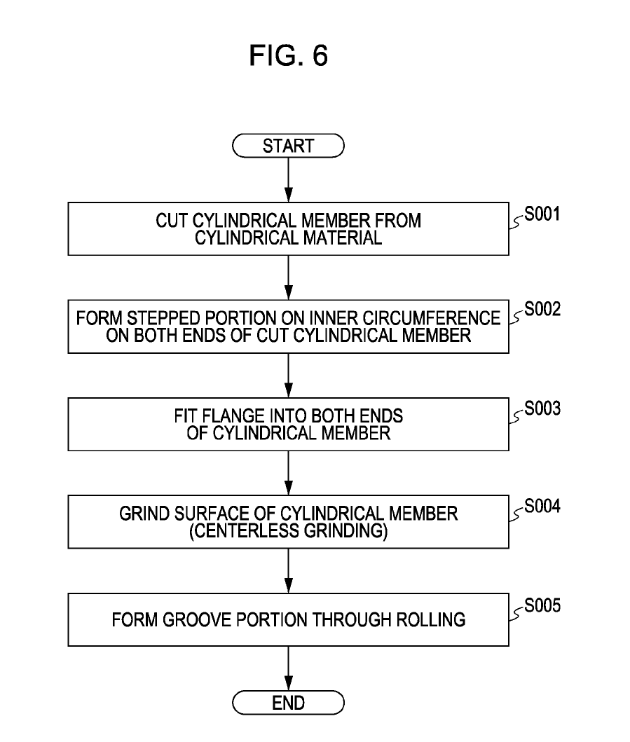

The developing roller 510 is fabricated by rolling. FIG. 5 is a view illustrating an aspect in which the developing roller 510 is fabricated by the rolling. FIG. 6 is a view illustrating the order of fabricating the developing roller.

The developing roller 510 is made of a cylindrical hollow material. First, the cylindrical hollow material is cut so as to form the center portion 510a for carrying the toner and the end portion 510b abutting against the end seal 527 as the developing roller 510, so that a cylindrical member 515 is cut (S001). The cylindrical member 515 is formed at inner circumferences of both ends thereof with the stepped portion 510c (FIG. 4) for fitting a flange 513 having an axis of the developing roller 510 by a grinding process (S002). The flange 513 has a disc-shaped flange body 513a having a diameter to be fitted into the formed stepped portion 510c and an axial portion 513b protruding from the center portion of the flange body in a direction perpendicular to a disc surface.

Next, the flange 513 having the axial portion 513b is respectively fitted into the cylindrical member 515 formed with the stepped portion 510c at inner sides of both ends in such a manner that the axial portion 513b protrudes outwardly from the cylindrical member (S003).

After that, the cylindrical member 515 fitted with the flange 513 is supported at the axial portions 513b of both ends, and is rotated around the axis, so that the outer circumference of the cylindrical member 515 is slightly ground over the whole circumference. As a result, the surface of the cylindrical member 515 is ground in such a way that the whole area of the surface is concentric to the axis, that is, is to be a constant distance L from the axis, thereby forming the developing roller 509 which is not subjected to the rolling process (S004).

The cylindrical member 515 with the ground surface is provided with on the surface thereof with two kinds of groove portions 511a and 511b by the rolling of a machine including dies 900 as two kinds of machining tools, as shown in FIG. 5 (S005). In the rolling machine, while two kinds of dies 900 placed in an opposite direction are rotated in the same direction, a work (herein, the unrolled developer roller 509) is placed, and then two kinds of dies 900 are pressed against the unrolled developing roller 509. The unrolled developing roller 509 is transported in an axial direction while rotating in a direction reverse to the rotation direction of the dies 900. The dies 900 are provided with a blade 900a for forming the above-described groove portions 511a and 511b, and the blades 900a are inclined so that the groove portion 511a and 511b, which are formed on the surface of the unrolled developing roller 509 by the blades, are straight. Although the portions of the dies 900 which abut against the surface of the unrolled developing roller 509 are provided with the blades 900a, the work is not positively ground at the rolling, but the work is pressed by pressing force to form the grooves. Further, at the rolling, both ends 510b of the unrolled developing roller 509 do not abut against the dies 900, so that a smooth surface with no concave/convex portions is left on both ends 510b. That is, the top surfaces 512a of the convex portions 512 which do not come in contact with the dies 900 on the center portion 510a of the developing roller 510, and both ends 510b not to be rolled are in a ground state so as to constantly maintain the distance L from the axis center C. That is, the top surfaces and the both ends are positioned at regular distance from the axis center C. The surface 510d of the developing roller 510 is almost covered by the bottom surface 511c of the groove portions 511a and 511b recessed by contact of the dies 900 and unfinished surface which does not come in contact with the dies 900. The developing roller 510 fabricated by the rolling may be subjected to, for example, electroless Ni-P plating, electrodeposition or hard chromium plating or the like.

The developing roller 510 is supplied with the toner from the toner supply roller 550 between the end seals 527 which abut against both ends 510b, and the layer thickness of the toner layer is restricted at the pressing position of the regulating blade 560. In this instance, the regulating blade 560 is pressed over both ends 510b and the center portion 510a of the developing roller 510. Since the distance L from the axis center C is equal at the both ends 510b of the developing roller 510 and the top surface 512a of the convex portion 512, the regulating blade 560 presses the developing roller 510 in a substantially flat state, without significant bending. For this reason, for example, an extremely large gap is not formed between the surface 510d of the developing roller 510 and the regulating blade 560 in the vicinity of a boundary between both ends 510b and the center portion 510a.

In addition, since the depth of the groove portion 511 is less than two times the volume average particle size of the toner particles, the toner particles entering the groove portion 511 are not overlapped with two or more in the depth direction in any inner position of the groove portions 511. That is, a lot of toner particles do not enter the groove portion 511, and when the toner particles are pressed on the regulating blade 560, most of the toner particles come in contact with either the surface 510d of the developing roller 510 or the surface of the regulating blade 560. Accordingly, since each toner particle T is easily rotated, and it is difficult for the toner particles to stay in the groove portion 511, it is possible to effectively charge the toner particles T. For this reason, in combination with states in which the toner particles are effectively carried on the developing roller 510 and the extremely large gap is not formed between the surface 510d of the developing roller 510 and the regulating blade 560, it is possible to prevent the toner particles T from leaking outwardly from the developers 51, 52, 53 and 54.

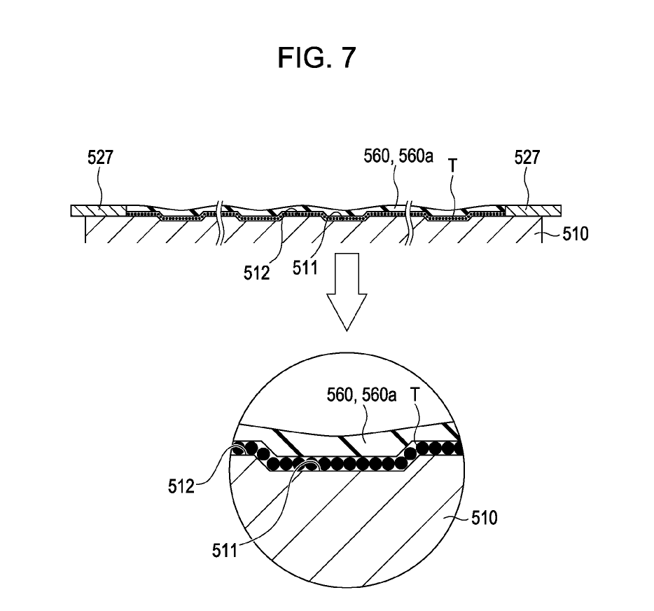

FIG. 7 is a view illustrating a state in which the regulating blade comes in contact with the developing roller carrying the toner particles. In particular, the depth of the groove 511 of the developing roller 510 according to this embodiment is 4 μm, and is less than substantially two times the volume average particle size (3 μm) of the toner particles T. For this reason, since the regulating blade 560 is made of rubber and follows the concave/convex portion of the surface 510d of the developing roller 510, it is possible to effectively charge the respective toner particles T in the whole area containing the convex portions 512 of the center portion 510a and the groove portions 511, thereby effectively carrying the toner particles on the developing roller 510. As a result, it is possible to enhance the transfer property at the development and thus to prevent the toner from leaking outwardly from the developer.

That is, if concave/convex portions with irregular size, depth and shape are formed on the surface 510d of the developing roller 510, since it is difficult for the toner particles, which enter the deep concave portion, among the carried toner particles to rotate, it is difficult to charge the toner particle. Further, in a case in which groove portions spaced apart from each other at a predetermined interval in an axial direction are formed in a circumferential direction, since the position of the photoreceptor 20 opposite to the groove portion in an axial direction is not varied even though the photoreceptor 20 rotates, a concentration of the developed toner image only at a portion opposite to the groove portion may be increased. Meanwhile, in a case in which groove portions are formed in an axial direction, since the rotation direction of the roller carrying the toner particles is substantially perpendicular to the direction of the groove portion, it is difficult for the carried toner particle to rotate, and thus to be charged.

According to the developers 51, 52, 53 and 54 and the developing roller 510 of this embodiment, the surface 510d of the developing roller 510 is provided with the spiral groove portions 511 having the inclination with respect to the axial direction and the circumferential direction of the developing roller, with the spiral groove portions being formed at regular pitch. Since the toner particles T are moved while rotating in accordance with rotation of the developing roller 510, it is possible to effectively charge the toner particles T. Further, since the opposite position between the photoreceptor 20 and the groove portion 511 is sequentially changed in the axial direction and the circumferential direction in accordance with rotation of the developing roller 510, it is possible to suppress the unevenness in the concentration of the developed toner image.

Further, since the developing roller 510 of this embodiment is formed with two kinds of groove portions 511a and 511b having different angle of inclination, the toner particles T are moved in two kinds of directions along the groove portions 511a and 511b. For this reason, it is possible to prevent the toner particles T from being inclined to one direction due to movement of the toner particles T towards one direction. In addition, since two kinds of groove portions 511a and 511b are intersected with each other in a lattice form, the toner particle T starting to rotate along one of the groove portions 511a and 511b can be rotated along the other of the groove portions 511a and 511b in the middle of movement. For this reason, it is possible to effectively suppress the movement direction of the toner particles T from being inclined towards one direction.

In addition, since the top surface 512a of the convex portion 512 enclosed by two kinds of groove portions 511 is formed in a square shape and one of two diagonal lines of the square top surface runs along a circumferential direction, the convex portion 512 has two rectangular apex angles positioned along a circumferential direction, and two rectangular apex angles positioned along an axial direction, two kinds of groove portions 511a and 511b have the same angle of inclination in the circumferential direction and the axial direction. For this reason, the developing roller can be configured to easily move the toner particles T equally in the circumferential direction and the axial direction. For this reason, it is possible to uniformly charge the toner particles by rotating the toner particles evenly.

Further, since the layer thickness of the toner particles T carried on the surface of the developing roller 510 is regulated on the plane of the rubber portion 560a having the regulating blade 560, the toner particles T carried on the surface of the developing roller 510, namely the convex portions 512, are not fully scrapped by the regulating blade 560. That is, in the groove portion 511 of the developing roller 510, it is possible to regulate the layer thickness of the toner particles T in the state in which the toner particles T are carried on the convex portion 512. Further, since the toner particles T carried on the surface 510d are pressed by the plane of the regulating blade 560, the toner particles T are rubbed by either the surface of the developing roller 510, the regulating blade 560, or other toner particles, so that the toner particles T are effectively charged.

Further, in a case in which the toner is supplemented, the developing toner may employ a toner mixed with the remaining toner and the newly supplemented toner, or in a case in which the toner is not supplemented, the developing toner may employ a toner mixed with the remaining toner and a newly filled toner.

Examples of the invention will now be described in detail.

### EXAMPLE

After 2 kg of base toner particles obtained by the above-described emulsion aggregation method were input in a Henschel mixer (20 L), 1.0 g of particles of large particle size which were selected from large particle alumina, large particle cerium oxide, large particle titania, which are shown in a column of Tables 1 to 4, and 1.0 g of particles of small particle size which were selected from small particle transition alumina and small particle titania, which were shown in a row were combined and put as an addition amount per 100 g of base toner particles (average volume particle size of 3.0 μm), as well as 2.0 g of small particle silica (‘RX200’ produced by Nippon Aerosil co., Ltd., 12 nm primary particle size, HMDS (hexamethylsilazone) product) and 0.5 g of large particle silica ('KEP10S′ produced by Nippon Shokubai Co., Ltd., 100 nm primary particle size, silicon oil product), and then were treated at a circumferential velocity of 40 m/s for 2 minutes. After the treatment, coarse particles were removed by using a sonic sifter employing a metal mesh of 63 μm mesh, and then the particles were used as toner.

In this instance, in Tables 1 to 4, the case of combined and using the large particle alumina¹⁾ and the large particle cerium oxide²⁾⁻⁴⁾ as the particles of large particle size, and the transition alumina particles^{10) to 13)} as the particles of small particle size is the example of the invention. Further, a case of using the titania⁵⁾ having a particle size of 100 to 300 nm as the particles of large particle size, a case of using the titania¹⁴⁾ having a particle size of 14 nm as the particles of small particle size, and a case with no external additive are comparative examples.

### Image Formation

Each of the obtained toners was mounted in an image forming apparatus (LP9000C produced by Seiko Epson) shown in FIG. 1. The developing roller was a product formed by the rolling, in which a surface of a iron raw pipe of φ=18 mm and a length of 370 mm was provided with a spiral groove with pitch of 80 μm at an angle of 45° in an axial direction and a circumferential direction, as the shape shown in FIG. 4, and the groove had a shape having a top surface of 30 μm width, a non-top surface of 50 μm and a depth of 4 μm.

Further, the layer thickness regulating member was made of silicon rubber, urethane rubber or the like, of which a thickness was 2 mm and rubber hardness was JIS-A 65, and was supported by a layer thickness regulating member supporting member. The layer thickness regulating member supporting member was constituted of a thin plate and a thin-plate supporting member, and supported the layer thickness regulating member at one end thereof in a widthwise direction. The thin plate was made of phosphor bronze, stainless or the like having a thickness of 0.15 mm, and had a spring property. The thin plate directly supported the layer thickness regulating member, and pushed the layer thickness regulating member on the developing roller by the pressing force. As a regulating form of the layer thickness regulating member, a control form (so-called edge regulation) was employed in which a distal end of the layer thickness regulating member in a widthwise direction and a thickness direction thereof was positioned in an abutting nip having a predetermined width. Further, a regulating bias of 150 V was applied to the layer thickness regulating member. Further, the supply roller was made of urethane sponge having an outer diameter of φ19 and an Asker F hardness of 70°, and was crimped on the developing roller at a contact depth of 1.0 mm.

In addition, under conditions set by the followings: a process velocity (circumferential velocity of photoreceptor) was set to 210 mm/s; a dark potential of the photoreceptor was set to −550 V; a bright potential of the photoreceptor was set to −50 V; a circumferential velocity of the developing roller was set to 336 mm/s; a circumferential velocity of the supply roller was set to 504 mm/s; a circumferential velocity ratio of the photoreceptor and the developing roller was set to 1.6; a circumferential velocity ratio of the developing roller and the supply roller was set to 1.5; and

a gap between the photoreceptor and the developing roller: 100 μm
an AC bias component Vpp of the photoreceptor and the developing roller: 1100 V
a DC bias component Vdc of the photoreceptor and the developing roller: −300 V
an AC frequency (f) of the photoreceptor and the developing roller: 6 kHz
an AC duty (a rate of time applied to a scrap side) of the photoreceptor and the developing roller: 60%, a color image is formed by an AC jumping development method. In this instance, a patch sensor for regulating a toner amount was not operated. Further, a test environment was 22 to 24° C./45 to 55% RH.

Next, development gap scattering and toner supplementation/development gap scattering were evaluated on each of the obtained toners by using an actual device. The evaluation method is given below.

### Development Gap Scattering

The expression ‘development gap scattering’ means a phenomenon in which when the toner on the developing roller is transferred to the photoreceptor by the AC electric field applied between the photoreceptor and the developing roller, a part of the toners activated by reciprocal movement under the AC electric field is not captured by the development electric field, but is scattered around the developing roller by an air flow. Quantification of the scattering determines the score below by comparing an adhered state of the toner captured by a surface of an adhesive tape at a corner of 1 cm which is positioned by taking a point separated by 10 mm from the closest point between the photoreceptor and the developing roller 10 toward a vertical direction of a line connecting both center axes as a ridge line, with a limit sample of an image enlarged by a microscope which has been previously prepared. The result is shown in Tables 1 and 2.

Lv4(◯): a state in which the toner captured on the adhesive surface is 5 pieces/1 cm² or less,
Lv3(Δ): a state in which the toner captured on the adhesive surface is 5 pieces/1 cm² or more, and 20 pieces/1 cm² or less,
Lv2(x): a state in which the toner captured on the adhesive surface is 20 pieces/1 cm² or more, and 100 pieces/1 cm² or less, and
Lv1(x): a state in which the toner captured on the adhesive surface is more than 100 pieces/1 cm².

Each of external additives used in Tables 1 to 4 is given below.

¹⁾: ‘Taimicron TM-DAR’ α-alumina produced by Taimei Chemicals Co., Ltd., a particle size of 160 nm,

²⁾: ‘s’ cerium oxide produced by Anan Kasei Co., Ltd., a particle size of 50 to 100 nm,
³⁾: ‘AU’ cerium oxide produced by Shin-Etsu Chemical Co., Ltd., a particle size of 50 to 100 nm,
⁴⁾: ‘UU’ cerium oxide produced by Shin-Etsu Chemical Co., Ltd., a particle size of 200 to 400 nm,
⁵⁾: ‘HT1701’ titania produced by Toho Titanium Corporation, a particle size of 100 to 300 nm,
¹⁰⁾: ‘Taimicron TM-100’ O-alumina phase produced by Taimei Chemicals Co., Ltd., a particle size of 14 nm,
¹¹⁾: ‘Taimicron TM-300’ γ-alumina phase produced by Taimei Chemicals Co., Ltd., a particle size of 7 nm,
¹²⁾: ‘C805’ alumina, γ-alumina phase (2/3), δ-alumina phase (1/3), produced by Nippon Aerosil Co., Ltd., a particle size of 13 nm,
¹³⁾: ‘Nano•Tek’ alumina, α-alumina phase (2/3) being a main phase and α-alumina phase being partial, produced by C.I. Kasei Co., Ltd., a particle size of 30 nm, and
¹⁴⁾: ‘STT30S’ titania, produced by Titan Kogyo, Ltd., a particle size of 14 nm,

TABLE 1

| | Alumina | Alumina | Alumina |
|---|---|---|---|
| | (θ) | (γ) | γ:δ = 2:1 |
| | (14 nm)¹⁰⁾ | (7 nm)¹¹⁾ | (13 nm)¹²⁾ |
| α alumina (160 nm)¹⁾ | Lv4 | Lv3 | Lv3 |
| Cerium oxide (50-100 nm)²⁾ | Lv4 | Lv3 | Lv3 |
| Cerium oxide (50-100 nm)³⁾ | Lv4 | Lv3 | Lv3 |
| Cerium oxide (200-300 nm)⁴⁾ | Lv4 | Lv3 | Lv3 |
| Titania (100-300 nm)⁵⁾ | Lv1 | Lv1 | Lv1 |
| None | Lv1 | Lv1 | Lv1 |

TABLE 2

| | Alumina | | |
|---|---|---|---|
| | γmain (α | | |
| | portion) | Titania | |
| | (30 nm)¹³⁾ | (14 nm)¹⁴⁾ | None |
| α alumina (160 nm)¹⁾ | Lv2 | Lv1 | Lv1 |
| Cerium oxide (50-100 nm)²⁾ | Lv2 | Lv1 | Lv1 |
| Cerium oxide (50-100 nm)³⁾ | Lv2 | Lv1 | Lv1 |
| Cerium oxide (200-300 nm)⁴⁾ | Lv2 | Lv1 | Lv1 |
| Titania (100-300 nm)⁵⁾ | Lv1 | Lv1 | Lv1 |
| None. | Lv1 | Lv1 | Lv1 |

Giving an example in Table 1, in a case in which 2.0 g of small particle silica and 0.5 g of large particle silica are added to the base toner particles as an external additive, and 1.0 g of large particle alumina and 1.0 g of small particle transition alumina are added to the base toner particles, the result of the development cap scattering is shown as Lv4. Further, giving a comparative example in Table 2, in a case in which 2.0 g of small particle silica and 0.5 g of large particle silica are added to the base toner particles as an external additive, and 1.0 g of large particle alumina and 1.0 g of small particle titania are added to the base toner particles, the result of the development cap scattering is shown as Lv1.

### Toner Supplement/Development Gap Scattering

After a white plain image is formed by amounts corresponding to 6000 sheets of A4 size and fogging toner amounts are consumed, the developing device is supplemented with a new toner by an amount corresponding to 10% of the remaining toner. The expression ‘toner supplement/development gap scattering’ means a phenomenon in which the development gap scattering occurring on the white plain image formed immediately after supplement of the developing device with the new toner is temporarily increased. The judgment of the toner supplement/development gap scattering is performed by the same order as the judging method of the fogging. The result is shown in Tables 3 and 4.

Lv4(◯): a state in which the toner captured on the adhesive surface is 5 pieces/1 cm² or less,
Lv3(Δ): a state in which the toner captured on the adhesive surface is 5 pieces/1 cm² or more, and 20 pieces/1 cm² or less,
Lv2(x): a state in which the toner captured on the adhesive surface is 20 pieces/1 cm² or more, and 100 pieces/1 cm² or less, and
Lv1(x): a state in which the toner captured on the adhesive surface is more than 100 pieces/1 cm².

TABLE 3

| | Alumina | Alumina | Alumina |
|---|---|---|---|
| | (θ) | (γ) | γ:δ = 2:1 |
| | (14 nm)¹⁰⁾ | (7 nm)¹¹⁾ | (13 nm)¹²⁾ |
| α alumina (160 nm)¹⁾ | Lv4 | Lv3 | Lv3 |
| Cerium oxide (50-100 nm)²⁾ | Lv4 | Lv3 | Lv3 |
| Cerium oxide (50-100 nm)³⁾ | Lv4 | Lv3 | Lv3 |
| Cerium oxide (200-300 nm)⁴⁾ | Lv4 | Lv3 | Lv3 |
| Titania (100-300 nm)⁵⁾ | Lv1 | Lv1 | Lv1 |
| None | Lv1 | Lv1 | Lv1 |

TABLE 4

| | Alumina | | |
|---|---|---|---|
| | γ main (α | | |
| | portion) | Titania | |
| | (30 nm)¹³⁾ | (14 nm)¹⁴⁾ | None |
| α alumina (160 nm)¹⁾ | Lv2 | Lv1 | Lv1 |
| Cerium oxide (50-100 nm)²⁾ | Lv2 | Lv1 | Lv1 |
| Cerium oxide (50-100 nm)³⁾ | Lv2 | Lv1 | Lv1 |
| Cerium oxide (200-300 nm)⁴⁾ | Lv2 | Lv1 | Lv1 |
| Titania (100-300 nm)⁵⁾ | Lv1 | Lv1 | Lv1 |
| None | Lv1 | Lv1 | Lv1 |

As would be understood from Tables 1 to 4, in the invention, even small particle toner can be used as toner which has superior uniformity of charging and does not leak from the developing device and is not scattered in the image forming apparatus or outwardly from the image forming apparatus. Further, it would be understood that the invention may be used in the image forming method and the image forming apparatus.

The entire disclosure of Japanese Patent Application No. 2009-097942, filed Apr. 14, 2009 is expressly incorporated by reference herein.

What is claimed is:

1. A toner comprising:
at least a binder resin, a colorant, and a release agent,
wherein there is contained base toner particles having an average volume particle size of 2 μm to 6 μm, small particle silica having an average volume particle size of 7 nm to 15 nm, large particle silica having an average volume particle size of 50 nm to 400 nm, small particle transition alumina having an average volume particle size of 7 nm to 20 nm, and large particle α-type alumina having an average volume particle size of 50 nm to 400 nm or large particle cerium oxide having an average volume particle size of 50 nm to 400 nm.

2. The toner according to claim 1, wherein the base toner particles have an average particle size of 2 μm to 4 μm and are manufactured by an emulsion polymerization method.

3. An image forming method comprising:
a photoreceptor that carries an electrostatic latent image; and
a developing device that is positioned opposite to the photoreceptor in a non-contact state,
the developing device including a developing roller having a surface carrying toner for developing the electrostatic latent image carried on the photoreceptor, and spiral groove portions with an inclination with respect to an axial direction and a circumferential direction formed on the surface at a regular pitch in the axial direction,
a supply roller for supplying the toner to the developing roller, and
a layer thickness regulating member applying a regulating bias to the developing roller to carry the toner on the developing roller,
wherein the electrostatic latent image carried on the photoreceptor is developed under an AC electric field by supplying the toner to the developing device, and
the toner includes at least a binder resin, a colorant, and a release agent,
in which there is contained base toner particles having an average volume particle size of 2 μm to 6 μm, small particle silica having an average volume particle size of 7 nm to 15 nm, large particle silica having an average volume particle size of 50 nm to 400 nm, small particle transition alumina having an average volume particle size of 7 nm to 20 nm, and large particle α-type alumina having an average volume particle size of 50 nm to 400 nm or large particle cerium oxide having an average volume particle size of 50 nm to 400 nm.

4. An image forming apparatus comprising:
a photoreceptor that carries an electrostatic latent image; and
a developing device that is positioned opposite to the photoreceptor in a non-contact state,
the developing device including a developing roller having a surface carrying toner for developing the electrostatic latent image carried on the photoreceptor, and spiral groove portions with an inclination with respect to an axial direction and a circumferential direction formed on the surface at a regular pitch in the axial direction,
a supply roller for supplying the toner to the developing roller, and
a layer thickness regulating member applying a regulating bias to the developing roller to carry the toner on the developing roller,
wherein the electrostatic latent image carried on the photoreceptor is developed under an AC electric field by supplying the toner to the developing device, and
the toner includes at least a binder resin, a colorant, and a release agent,
in which there is contained base toner particles having an average volume particle size of 2 μm to 6 μm, small particle silica having an average volume particle size of 7 nm to 15 nm, large particle silica having an average volume particle size of 50 nm to 400 nm, small particle transition alumina having an average volume particle size of 7 nm to 20 nm, and large particle α-type alumina having an average volume particle size of 50 nm to 400 nm or large particle cerium oxide having an average volume particle size of 50 nm to 400 nm.
